(19) United States
(12) Patent Application Publication
(10) Pub. No.: US 2016/0267581 A1
(43) Pub. Date: Sep. 15, 2016

(54) Receipt Tip Tracking

(71) Applicants: Xin Huang, Redmond, WA (US); Yingtao Dong, Redmond, WA (US)

(72) Inventors: Xin Huang, Redmond, WA (US); Yingtao Dong, Redmond, WA (US)

(21) Appl. No.: 14/656,854

(22) Filed: Mar. 13, 2015

(51) Int. Cl. G06Q 40/00

(52) U.S. Cl. CPC G06Q 40/00

(57) ABSTRACT

Ways to easily calculate tips related to a shift or day of service are disclosed. Receipts with several signature locations with each location corresponding to a different amount of a tip may be used to allow a customer to easily indicate how much of a tip is being left. The receipts may be presented on paper or on a device. If the receipts are on paper, they may be scanned. An application on a user device or a server may determine which location was signed, and tip amounts may be calculated and tallied automatically.

### FIELD

This disclosure relates generally to a Receipt Tip Tracking.

### BACKGROUND

When a person leaves a tip for service, the tip is often written on a receipt after the amount has been entered into a point-of-sale system. This often leads to staff adding up tips listed on receipts at shift end. In a busy restaurant, this can take an hour or more of error-prone manual calculations when staff are tired and ready to go home.

Patrons must often manually calculate a tip, in many cases relying on a calculator to determine an amount corresponding to a percentage the patron wishes to leave.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, Receipt Tip Tracking, which may include ways for a business, a restaurant, for example, to quickly total tips at the end of a shift. For example, a restaurant may have a customer sign at a particular location on a device, or on a paper receipt, which may indicate a tip amount. Each location may correspond to a particular percentage of the bill as a tip. For example, the first location may correspond to a 15% tip, the second location a 20% tip, the third location a 25% tip, and the fourth location a custom tip. In this example, if the patron wishes to leave a 15% tip, the patron may sign at the first location of the receipt. If a paper receipt is used, it may be scanned using a device such as a receipt scanner, smart phone, smart watch or intelligent eyewear, for example. The value of the tip may be calculated based on the placement of the customer signature. This may also improve service to the patron. For example, a patron may not need to use a calculator to compute a tip amount, the patron may simply identify what percentage of the bill the patron wants to leave as a tip, and sign a corresponding location. Using a location of signing to represent a tip may simplify scanning to determine the tip amount.

### BRIEF DESCRIPTION OF THE DRAWINGS

FIG. 1 illustrates a system capable of supporting a Receipt Tip Tracking System, according to one embodiment.

FIG. 2 is a flow diagram illustrating Receipt Tip Tracking according to one embodiment.

FIG. 3 illustrates a user interface layout for a device application using a Receipt Tip Tracking System, according to one embodiment.

FIG. 4 is a component diagram of a computing device to which a Receipt Tip Tracking process may be applied according to one embodiment.

### DETAILED DESCRIPTION

Many of the attendant features may be more readily appreciated as they become better understood by reference to the following detailed description considered in connection with the attached drawings, in which like parts are assigned like numerals.

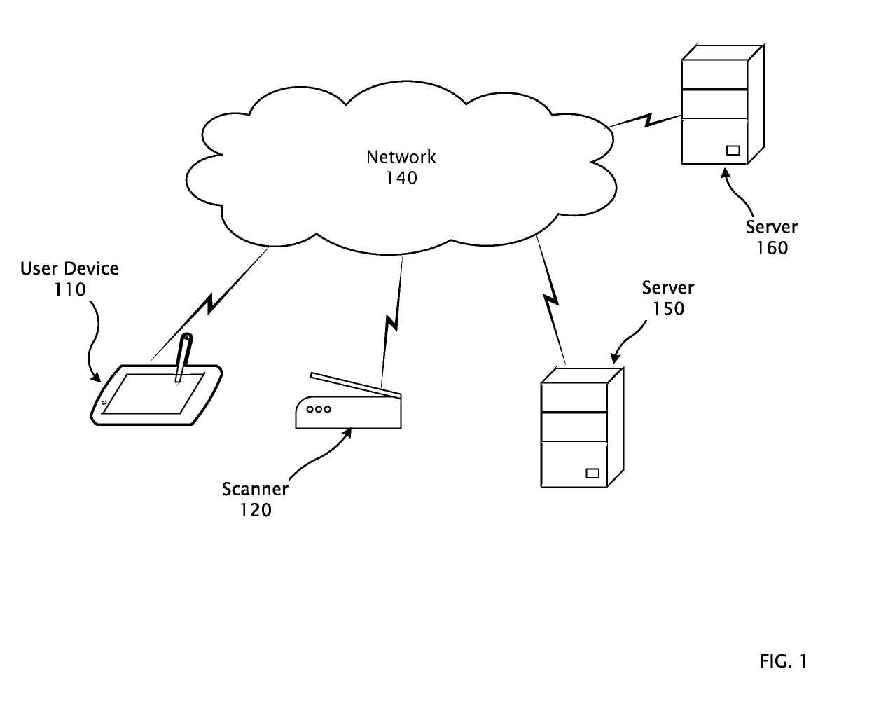

FIG. 1 illustrates a system capable of supporting Receipt Tip Tracking, according to one embodiment. For example, a restaurant may have a customer sign at a particular location on Device 110, or on a paper receipt, which may indicate a tip amount. Each location may correspond to a particular percentage of the bill as a tip. For example, the first location may correspond to a 15% tip, the second location a 20% tip, the third location a 25% tip, and the fourth location a custom tip. In this example, if the patron wishes to leave a 15% tip, the patron may sign at the first location of the receipt. If a paper receipt is used, it may be scanned using a device such as Scanner 120, which may be a receipt scanner, smart phone, smart watch or intelligent eyewear, for example. The value of the tip may be calculated based on the placement of the customer signature. This may also improve service to the patron, who may not need to use a calculator to compute a tip amount, but rather simply identify what percentage of the bill to leave as a tip. Staff may no longer need to add up tip amounts manually, reducing time and errors in the calculation.

Network 140 may include Wi-Fi, cellular data access methods, such as 3G or 4GLTE, Bluetooth, Near Field Communications (NFC), the internet, local area networks, wide area networks, USB connectivity, or any combination of these or other means of providing data transfer capabilities. In one embodiment, Network 140 may comprise Ethernet connectivity. In another embodiment, Network 140 may comprise fiber optic connections.

Device 110 may be a smartphone, tablet, laptop computer, smartwatch or intelligent eyewear, or other device, and may have network capabilities to communicate with Server 150. Server 150 may include one or more computers, and may serve a number of roles. Server 150 may be conventionally constructed or may be of a special purpose design for processing data obtained from a Smart Table Service. One skilled in the art will recognize that Server 150 may be of many different designs and may have different capabilities. Server 160 may include one or more computers, and may serve a number of roles. Server 160 may be conventionally constructed or may be of a special purpose design for processing data obtained from a Receipt Tip Tracking System. One skilled in the art will recognize that Server 160 may be of many different designs and may have different capabilities.

Device 110 may host an application to support Receipt Tip Tracking system, for example, allowing a user to leave a tip based on a percentage of the bill by signing in a particular location on Device 110. In another embodiment, Device 110 may display a web application hosted on Server 150 in a browser, which may allow a user to leave desired tip by signing in a particular location on Device 110. In yet another embodiment, paper receipts may be signed at a location indicating a tip amount and then scanned using Scanner 120.

In one embodiment, Server 150 may be operated by a third party. Server 150 may then communicate with Server 160, which may be operated by the establishment, allowing the establishment to receive notification of the calculated tips.

In another embodiment, Server 150 may be operated directly by an establishment offering Receipt Tip Tracking.

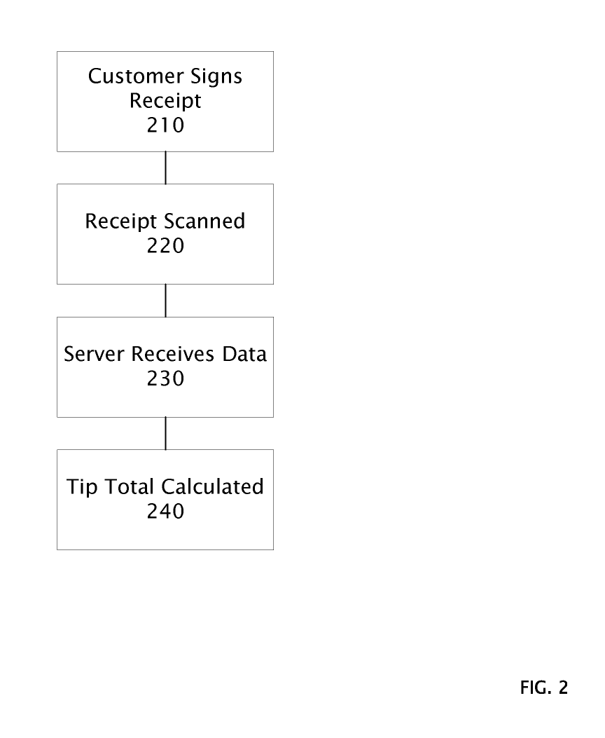

FIG. 2 is a flow diagram illustrating Receipt Tip Tracking according to one embodiment. A receipt may be presented to a customer, giving the customer an option to sign in one of several locations. Each location may represent a different tip amount. The receipt may be on paper, or may be presented on Device 110. Customer may Sign Receipt 210 at a location reflecting the tip amount the customer wishes to leave. If the receipt is on paper, it may be Scanned 220. This step may be skipped if the customer signed on Device 110. In either example, Server 150 may Receive Data 230 reflecting the tip amount. Receipt Tip Tracking may Calculate Total Tips 240.

Receipt Tip Tracking may be used in any commercial or non-commercial context. For example, in another embodiment, it may be used by silent bidders at an auction by allowing them to sign at a particular location to communicate to the auctioneer how much percentage over the base price the bidder is willing to bid.

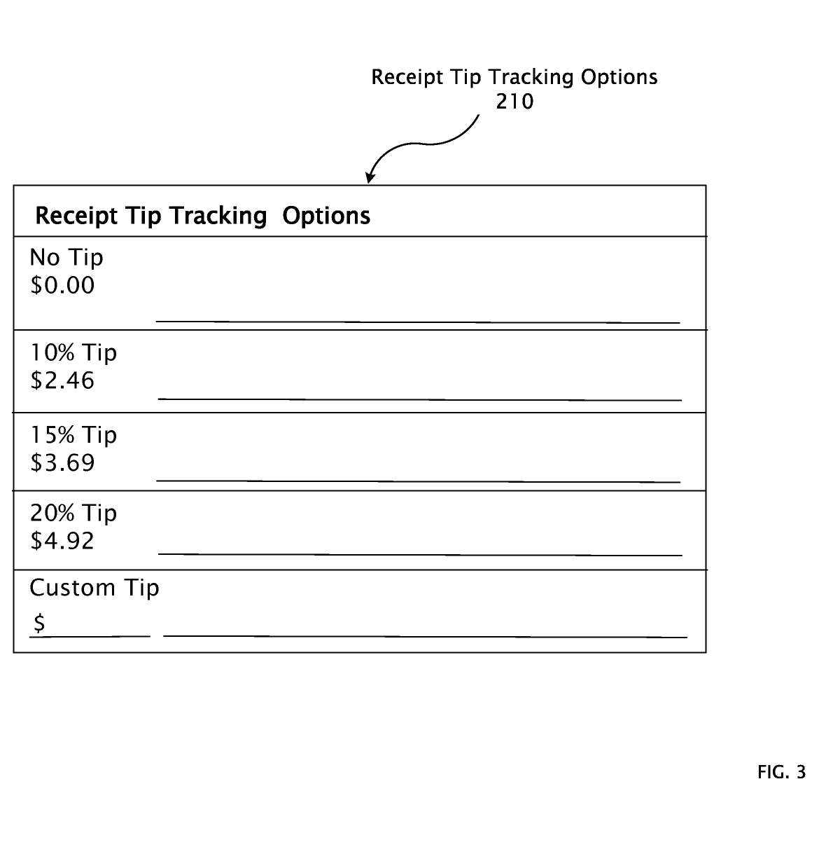

FIG. 3 illustrates a user interface layout for a device application using a Receipt Tip Tracking, according to one embodiment. Receipt Tip Tracking Options 210 may display several locations representing the tip the patron wishes to leave the staff. For example, in a restaurant context, a patron may sign a third location on a receipt to indicate that the patron wishes to leave a tip of 15%. In this example, a receipt may have been for an amount of $24.60, with the corresponding tips reflected as $2.46 for 10%, $3.69 for 15%, and $4.92 for 20%. Receipt Tip Tracking Options 210 may have various configurations, and it may be available in any language. For example, Receipt Tip Tracking may allow a person on an auction site to submit a bid of a certain percentage over the last bid for a particular item. Different tip percentages may be displayed, and may be configurable by an establishment. For example, one restaurant may display tip amounts of 10%, 15%, and 20%, while another may display 10%, 15%, 20%, and 25%. Different numbers of tip options may be configured.

Receipt Tip Tracking may display a percentage of a receipt, a tip amount in dollar and cents, a combination of both, or any other way to display a tip amount.

Receipt Tip tracking may scan a signed receipt to determine which location contains a signature, and may use that information to calculate a tip amount. Custom tip amounts may be scanned and calculated using optical character recognition (OCR). Invalid receipts, for example, unsigned receipts or receipts signed in multiple locations, or signed at a location not clearly identifying a patron's intent, may be automatically identified, and a scanned image may be stored for manual verification or correction.

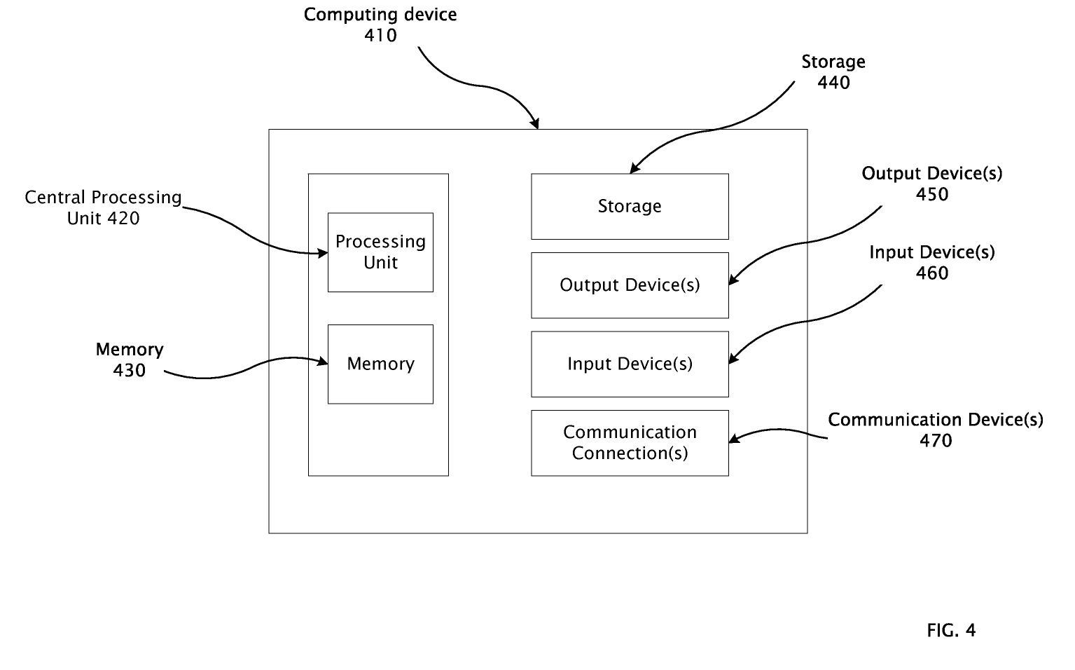

FIG. 4 is a component diagram of a computing device which may support Receipt Tip Tracking according to one embodiment. Computing Device 410 may be utilized to implement one or more computing devices, computer processes, or software modules described herein, including, for example, but not limited to a mobile device. In one example, the Computing Device 410 can be used to process calculations, execute instructions, and receive and transmit digital signals. In another example, the Computing Device 410 can be utilized to process calculations, execute instructions, receive and transmit digital signals, receive and transmit search queries and hypertext, and compile computer code suitable for a mobile device. The Computing Device 410 can be any general or special purpose computer now known or to become known capable of performing the steps and/or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), non-volatile (such as ROM, flash memory, etc.) or some combination of the two. Additionally, Computing Device 410 may also have additional features/functionality. For example, Computing Device 410 may include multiple CPU's. The described methods may be executed in any manner by any processing unit in computing device 410. For example, the described process may be executed by both multiple CPU's in parallel.

Computing Device 410 may also include additional storage (removable and/or non-removable) including, but not limited to, magnetic or optical disks or tape. Such additional storage is illustrated in FIG. 4 by Storage 440. Computer readable storage media includes volatile and nonvolatile, removable and non-removable media implemented in any method or technology for storage of information such as computer-readable instructions, data structures, program modules or other data. Memory 430 and Storage 440 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 410. Any such computer-readable storage media may be part of computing device 410. But computer readable storage media does not include transient signals.

Computing Device 410 may also contain Communications Device(s) 470 that allows the device to communicate with other devices. Communications Device(s) 470 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 410 may also have Input Device(s) 460 such as keyboard, mouse, pen, voice input device, touch input device, etc. Output Device(s) 450 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

The illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A method, comprising:
presenting, to a customer, a receipt comprising a plurality of locations available for signing, each location corresponding to a different tip amount;
receiving, from the customer, the receipt signed at one of the locations;
submitting to a server an amount of the receipt and an indicator of which of the locations was signed; and
receiving from the server a calculation of a tip amount, based on the receipt amount and the indicator of which location was signed.

2. The method of claim 1, wherein the indicator of which location was signed is obtained from a scan of a paper receipt.

3. The method of claim 1, wherein the indicator of which location was signed is obtained from an application on a device.

4. The method of claim 1, further comprising calculating a total of a plurality of tips.

5. A system, comprising:
a server, comprising:
a processor;
a memory coupled to the processor;
components operable on the processor, comprising:
a receipt data receiving component, configured to receive data corresponding to a receipt; the data comprising an amount of the receipt and a location of a signature on the receipt; and
a tip calculating component, configured to calculate a tip based on the location of the signature and on the amount of the receipt.

6. The system of claim 5, further comprising:
a receipt scanning device; and
software to determine a location of a signature on a scanned copy of a receipt.

7. A computer-readable storage media containing instructions thereon which, when executed by a processor, perform a method comprising:
presenting, to a customer, a receipt comprising a plurality of locations available for signing, each location corresponding to a different tip amount;
receiving, from the customer, the receipt signed at one of the locations;
submitting to a server an identifier of the receipt amount and an indicator of which location was signed; and
receiving from the server a calculation of a tip amount, based on the receipt amount and the indicator of which location was signed.
